(19) United States
(12) Patent Application Publication
(10) Pub. No.: US 2020/0352152 A1
(43) Pub. Date: Nov. 12, 2020

(54) Bedbug Trap With Carbon Dioxide Generator

(71) Applicant: Paul STEVENS, Anchorage, AK (US)

(72) Inventor: Paul STEVENS, Anchorage, AK (US)

(21) Appl. No.: 16/943,546

(22) Filed: Jul. 30, 2020

Related U.S. Application Data
(63) Continuation-in-part of application No. 15/594,931, filed on May 15, 2017, now Pat. No. 10,729,115.

(51) Int. Cl. A01M 1/02; A01M 1/10; A01M 1/20

(52) U.S. Cl. CPC A01M 1/023; A01M 2200/011; A01M 1/2011; A01M 1/103

(57) ABSTRACT

A bedbug trap that has a series of stacked containers. The top container holds a quantity of water, sugar and yeast, which generates carbon dioxide. The central container receives or supports the upper chamber, and includes a small heating pad to aid in the fermentation within upper chamber. A hose directs the generated carbon dioxide to the bottom chamber or holding tray. This chamber sits in a bowl that has a rough exterior and a smooth interior. Holes or a gap allows the carbon dioxide to escape into the room, which attracts the bedbugs. The assembled unit is large, to trap as many bedbugs as possible in the shortest amount of time. The water, sugar and yeast mixture serving as the generator are replenished as needed.

### CLAIM OF PRIORITY

The present continuation-in-part application includes subject matter disclosed in and claims priority to U.S. patent application Ser. No. 15/594,931, filed May 15, 2017, entitled “Bedbug Trap With Carbon Dioxide Generator” (U.S. Pat. No. 10,729,115), incorporated herein by reference, which describes an invention made by the present inventor.

### BACKGROUND OF THE INVENTION

### 1. Field of the Invention

This invention relates to bedbug traps and particularly to bedbug traps with carbon dioxide generators.

### 2. Description of the Prior Art

Bedbugs are an age old problem. Recently, there has been a resurgence of the pest. Bedbugs are notoriously difficult to get rid of because they populate many hidden areas within a room and within clothing and bedding. The only practical way to get rid of bedbugs is to lure them to a trap and then trap them. To that end, numerous bedbug traps have been invented recently. Some examples of such traps are found in U.S. Pat. Nos. 8,808,721; 8,904,701; 8,966,812; 9,220,254; and 9,986,763. All of these devices utilize the fact that bedbugs are attracted to humans (or other warm blooded animals) for food. This attraction involves, heat, carbon dioxide and, sometimes, lactic acid. All humans produce these by-products of life. All of the patents above use heat and carbon dioxide and, as noted, some include lactic acid. The differences between them is how they do that. Most generate carbon dioxide by using carbon dioxide canisters, such as those used in paint ball and other air guns. Heat is generated in a number of ways, such as using a lamp or small electric heater. The main problem with all of them is that they tend to be designed to be hidden. One patent refers to a stigma of having a bedbug infestation and by using a discreet device there will be no embarrassment of having a bedbug infestation. They are designed for the gradual elimination of bedbugs, even while people are living in the infested room. This, of course, is problematic because a small device can only generate limited signals. Moreover, use of one-time use canisters to generate carbon dioxide is expensive and requires frequent changing of the canisters. Finally, using such a device while a user continues to inhabit the room is almost self-defeating because, even if the trap is present, the bedbugs will also be attracted to the people.

It is therefore an object of the present invention to provide a bed bug trap that serves to attract bed bugs with locally generated carbon dioxide and heat, into a specially adapted capture tray.

It is a further object of the present invention to attract bed bugs with locally generated carbon dioxide and heat, and capture the bed bugs in a tray.

These and other objects of the present invention will become apparent to those skilled in the art as the description thereof proceeds.

### BRIEF DESCRIPTION OF THE INVENTION

The instant invention eliminates these problems. It is a large container system that generates carbon dioxide using inexpensive materials that can be easily replaced. Moreover, it is large enough to generate a larger heat signature, which helps to attract more bedbugs. And finally, it is designed to be used in an empty room. People are not supposed to be in the room while it is in operation to allow it to attract and trap as many of the bedbugs as possible in as short a time as possible.

The device uses a set of stacked containers. The top container holds a quantity of water, sugar and yeast, which is allowed to ferment, thus generating carbon dioxide. The central container holds a small heating pad. The pad not only generates heat to attract the bedbugs, it also heats the water and yeast mixture to aid in the fermentation. A hose with a water trap system brings the generated carbon dioxide from the upper chamber to the bottom chamber. This chamber sits in a container that has a rough exterior and a smooth interior. The user can place diatomaceous earth to aid in their demise in the lowest bowl if desired. Holes, formed around the base of the bottom chamber allow the carbon dioxide to escape into the room, which attracts the bedbugs. The fermentation process also produces the carbon dioxide in a series of “burps”, which also aids in the simulation of breathing. The assembled unit is large and is designed to have a significant impact in a room, thus ensuring the likelihood of trapping as many bedbugs as possible in the shortest amount of time. Finally, the water, sugar and yeast are common household items that are easily and cheaply replenished as needed.

Although not preferred, the unit can be made smaller so that travelers can use one in a hotel room, for example.

### BRIEF DESCRIPTION OF THE DRAWINGS

FIG. 1 is a perspective view of an assembled bedbug trap.

FIG. 2 is an exploded view of the bedbug trap showing the major components thereof.

FIG. 3 is a detail view of the middle container showing an insulation wrap therefor.

FIG. 4 is a top perspective view of the preferred water trap for the bedbug trap system.

FIG. 5 is a perspective view of an assembled bedbug trap showing an alternative water trap system.

FIG. 6 is a side exploded schematic view of the major elements of the bedbug trap showing assembly and operation of the trap.

FIG. 7 is an exploded view of an alternative embodiment of a bedbug trap showing the major components thereof.

FIG. 8 is a perspective view of an assembled alternative bedbug trap.

FIG. 9 is a cross-sectional view of the lower container tray of an alternative embodiment of a bedbug trap.

FIG. 10 is a bottom perspective view of the middle container of an alternative bedbug trap.

FIG. 11 is a perspective view of an alternative bedbug trap with an exploded chamber showing the layers therein.

FIG. 12 is a frontal side view of the alternative bedbug trap with the layers of the chamber removed.

FIG. 13 is a partial cutaway perspective view of the middle container of an alternative bedbug trap.

FIG. 14 is a partial cutaway perspective view of the middle container of an alternative bedbug trap with heater emplaced therein.

FIG. 15 is a perspective view of the disabled alternative bed bug trap with middle contain seated on tray.

### DETAILED DESCRIPTION OF THE INVENTION

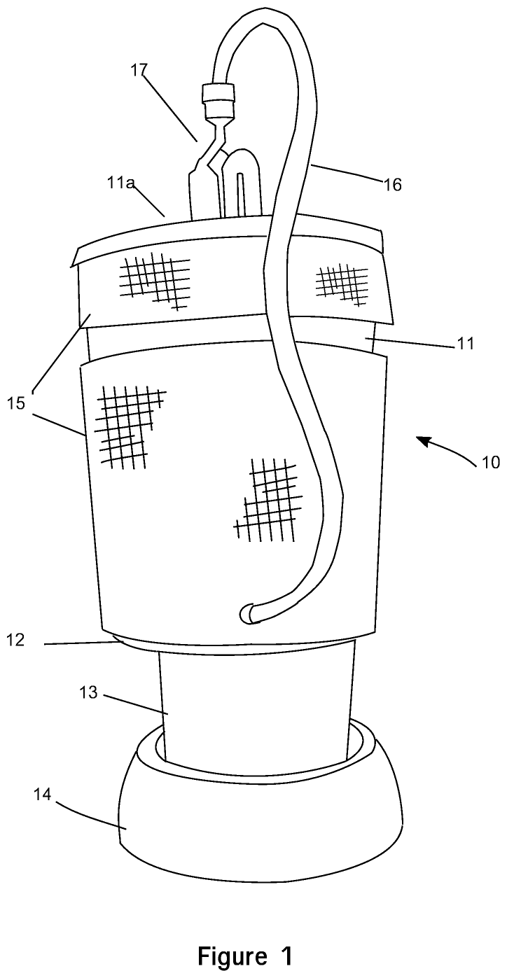

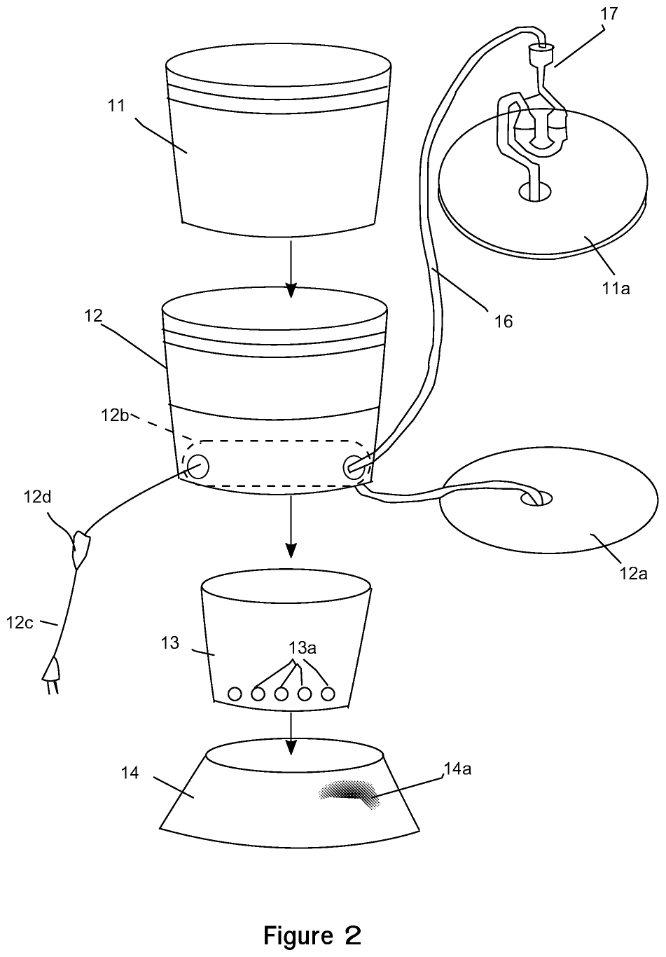

Referring now to the drawings and particularly, FIGS. 1 and 2, the bedbug trap 10 is shown. The trap 10 has a number of stacked and nested containers as shown in FIG. 1. FIG. 2 shows these containers in an exploded view. The uppermost container 11 is a large hollow vessel that has a removable top 11a. As discussed below, the sugar, water and yeast mixture is held in this container. This container is placed into the middle container 12. Note the bottom 12a of the middle container 12 This container is also a hollow vessel. A heating pad 12b is stored in the bottom of this container as shown. Note the power cord 12c of the heating pad 12b and the switch 12d. The upper container 11 is designed to fit on the top of the heating pad 12b, which enables heat to heat the sugar, water and yeast mixture is held in upper container 11.

As discussed above, the upper container 11 has a top 11a. This top is fit onto the top of the upper container as shown in FIG. 1. Note the insulation 15 placed around the upper container and the middle container. A tube 16 is used to carry the carbon dioxide (CO2), which is produced in the upper container, to the lower container 13. The hose 16 has an airlock attachment 17 attached as shown. The airlock 17 is filled with water. This causes the CO2 to pulse through the airlock. This pulsation simulates natural breathing. As shown, the hose 16 carries the CO2 to the bottom 12a of the middle container and it exits through the center of the bottom 12a as shown. In this way, the hose 16 injects the CO2 into the lower container 13. Note that the lower container 13 has a series of holes 13a formed in the lower portion of the lower container as shown. The CO2 from the upper container escapes into a room through these holes. As noted, the airlock provides pulsed supply of CO2 which, when combined with the heat generated by the heating pad 12b, attracts bedbugs. Note that the position of the heating pad also allows it to heat the lower container as well.

At the base of the bedbug trap 10 is the holding container 14. As shown, the lower container 13 fits into the holding container. The outer surface of the lower container 14a has a rough surface (note the rough surface covers the entire outer surface of the container) that allows the bedbugs to climb into the holding container. The inside of the holding container is smooth so that the bedbugs, once in the holding container 14 are trapped. It is possible to add some powered insecticide, such as diatomaceous earth, to kill the bedbugs quickly. In use, bedbugs are found in both the holding container 14 and in the lower container 13.

After the device has been assembled, sugar/yeast/water mixture has been added and the heating pad is turned on, the operation of the device is automatic. Once the sugar/yeast/water mixture starts to release CO2 the bedbugs are attracted to it. Over time, one simply has to replenish the sugar/yeast/water mixture and to clean out the holding and lower containers.

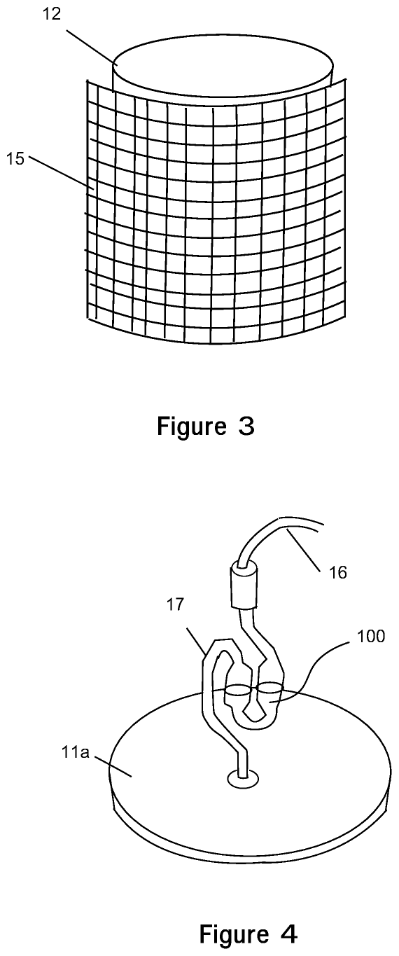

FIG. 3 is a detail view of the middle container showing an insulation wrap 15 therefor. As noted above, and as shown in FIG. 1, the middle container 12 and a portion of the upper container are wrapped with insulation 15 to concentrate the heat from the heating pad and to present a heat signature towards the lower container, in conceit with the emission of the CO2.

FIG. 4 is a top perspective view of the preferred water trap for the bedbug trap system. As noted above, a brewing S-type airlock 17 is preferably used to pulse the CO2 from the upper container out to the lower container. Note that the water 100 trapped in the airlock also acts to contain any odor emitted from the upper container.

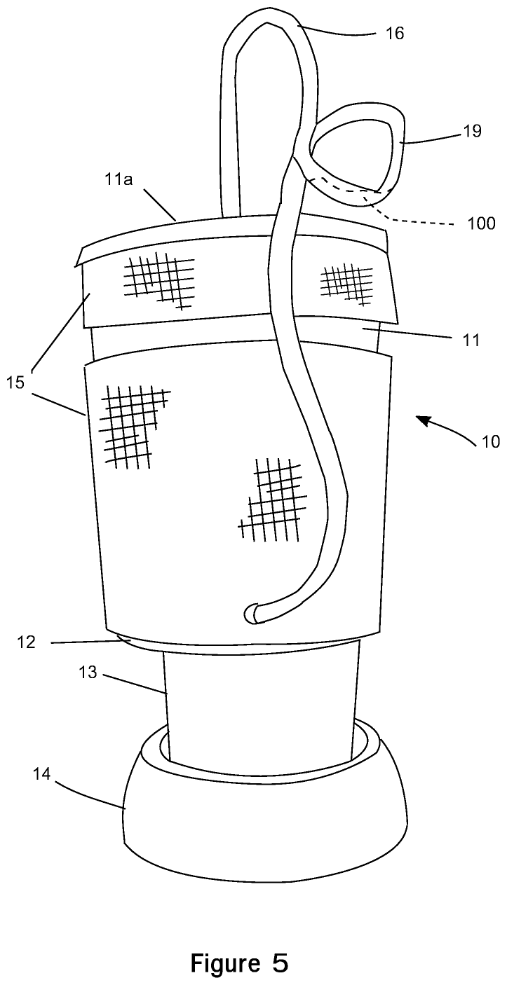

FIG. 5 is a perspective view of an assembled bedbug trap showing an alternative water trap system. The device also works by making a loop 19 in hose 16 and adding a small amount of water 100, that is trapped in the loop 19. This allows the CO2 to escape and still provides a pulsating delivery of the gas. Although this alternative works, it is not preferred.

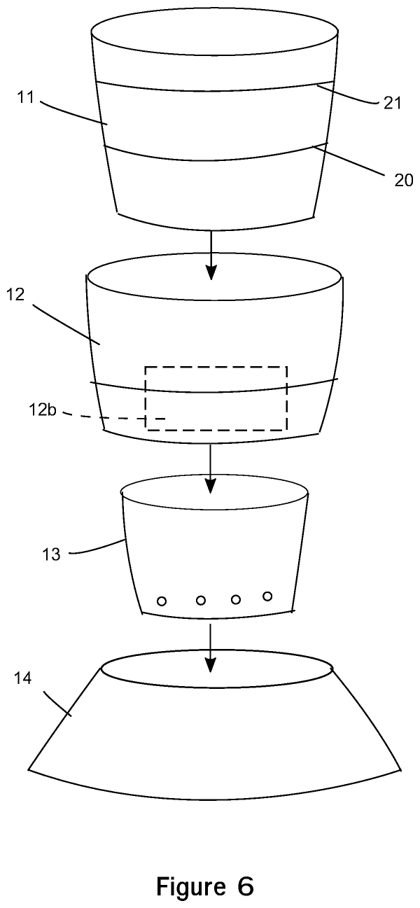

FIG. 6 is a side exploded schematic view of the major elements of the bedbug trap showing assembly and operation of the trap. This figure does not show all of the elements used in the trap. However, it does provide a guide for the assembly of the trap.

To assemble the trap, the following steps are needed. First, mix a desired amount of water, sugar and yeast. As shown in the figure, the upper container 11 has two marks on it. One of a one-gallon mark 20 and the second is a two-gallon mark 21. More water and yeast yields more CO2. In the preferred embodiment, two gallons of water at 100° F. mixed with 6 cups of sugar and 3 tablespoons of yeast are used. It is important to measure the levels accurately and to monitor the temperature. When the water reaches 100° F., put the lid 11a with the airlock 17 in place (and filled according to the marks on the airlock) on the upper container. The temperature of the water should be between about 105 and 107 degrees F. to produce optimum levels of CO2. However, a temperature above 100 degrees F. will kill the yeast and stop CO2 production.

Next, attach the hose 16 to the airlock and place the upper container into the middle container 12. As this point, the heating pad 12b is turned on. Note that the hose 16 is already installed in the middle container and runs out the bottom of the middle container as shown in FIG. 2.

Next, the lower container 13 is placed in the holding container 14. Note that, if desired, a quantity of diatomaceous earth can be added to the holding container. Then the upper and middle container are placed on the lower container 13, ensuring that the hose 16 extends down into the lower container 13. The trap is now assembled and ready for operation.

Bedbugs are attracted to the device and will climb the outer surface of the holding container 13. Once inside, the slick surface keeps them within the holding container. Bedbugs may also enter the lower container as well. All trapped bedbugs can be disposed of and the trap parts cleaned and reset. In this way, bedbugs can be conveniently and assuredly trapped and destroyed.

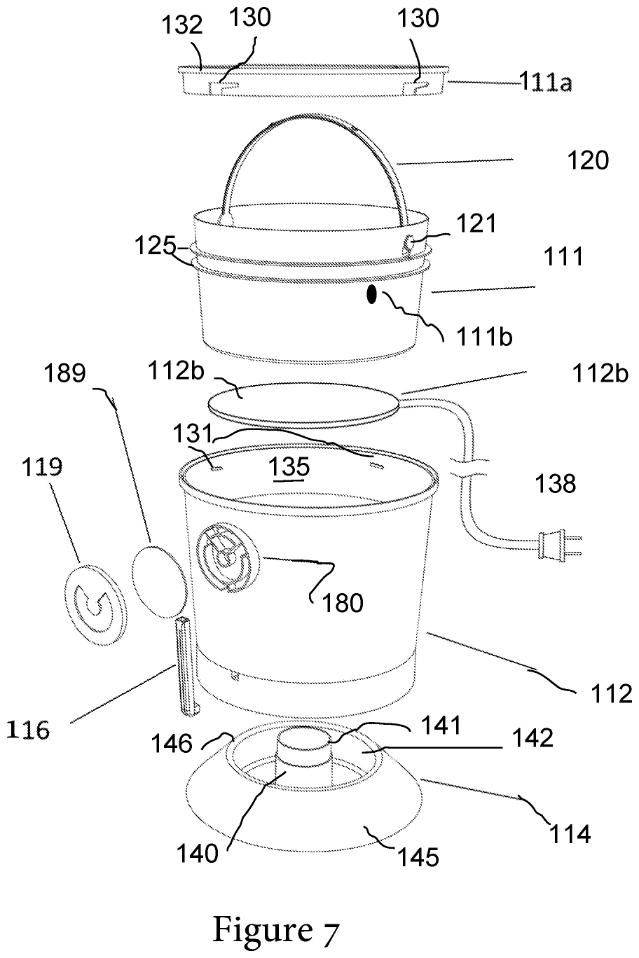

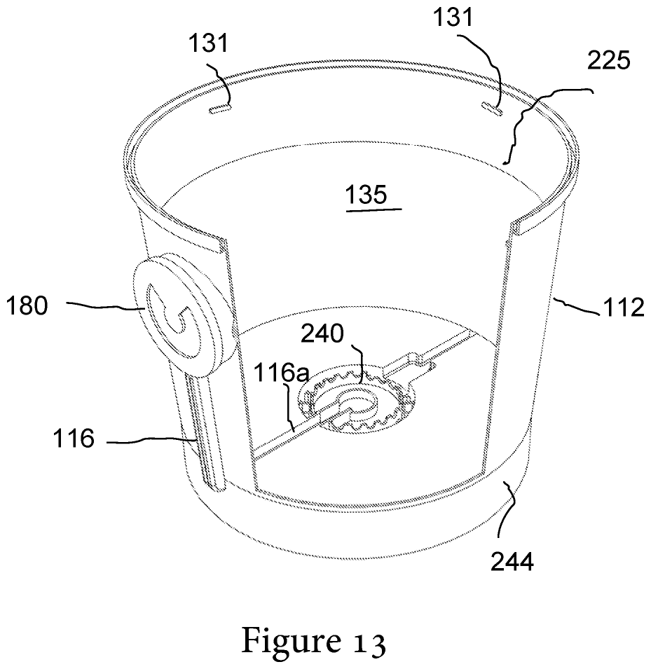

FIG. 7 introduces an alternative embodiment of a bedbug that combines the lower container with the holding container/tray. Middle container 112 provides the housing for upper container 111 with heating element 112b set therein. Upper container 111 includes dual circumferential flanges to provide an air tight seal surrounding the bottom of the upper container when placed in a nesting fashion within middle container. When emplaced, upper container rests against middle container side walls, and does not rest at bottom of middle container, and preferably does not physically contact heating element 112b. Preferably, upper container rests on interior ledge 225 (shown in FIG. 13) of middle container 112 and provides an airtight seal against middle container interior surface 135. Upper container may include at least one aperture 111b to provide for fluid communication with the interior of middle container when emplaced and sealed therein. Preferably, when used, the aperture is below the lower of the dual flanges. Water-sugar-yeast mixture is prepared in the upper container 111, and then lid 111a is emplaced on the top of upper container, whereby circumferential sealing flange 132 provides an airtight seal with the interior of upper container. Nested slots 130 are provided in lid 11a to lock and seal with middle chamber 112 via extending tabs 131. In embodiments without aperture, lid 111a provides a seal within middle chamber 112 somewhat above the top of upper chamber, thus exposing the top opening of upper chamber within sealed middle chamber 112 when upper chamber is emplaced therein and resting on ledge.

After the mixture is set in upper chamber, upper chamber may be lowered into middle chamber manually via articulating handle 120, which can pivot or rotate via pivot mechanism 121 as is known in the art. As an alternative to aperture 111b, and alternative or in combination to exposed open top of upper container, holes at pivot mechanism 121 in upper chamber 111 may serve to provide fluid communication with the interior of middle chamber.

Heating element 112b is set at bottom of middle chamber 112, preferably before emplacing upper container. Heating element 112b is adapted to heat the upper chamber mixture to approximately 80 degrees Fahrenheit, and maintain this temperature of mixture to provide a steady, yet not overly aggressive reaction of yeast—so as to provide a long-lived, healthy, yet productive and steady supply of CO₂. Power cord 138 preferably provides electric power to a resister in heating element 112b to maintain heating. Cord may be set through the wall of middle container, but the cord outlet must be sealed to ensure the air-tightness of the interior surface 135 of middle container, when assembled, except for passageway (discussed below).

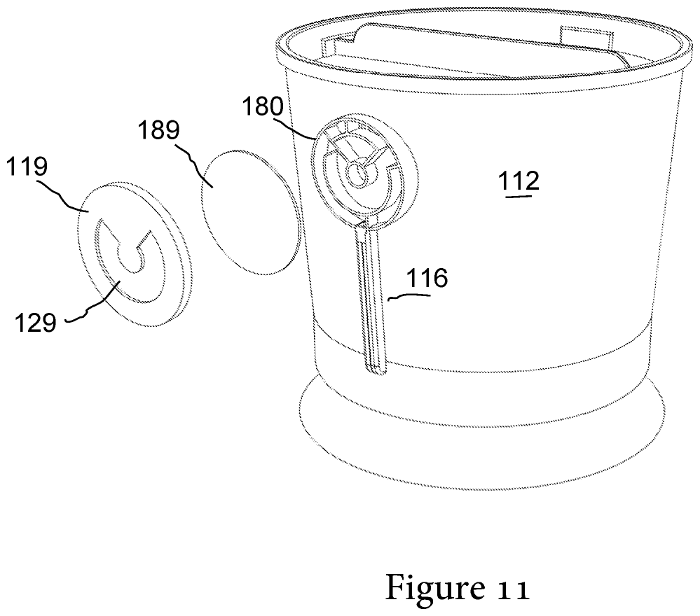

Middle container 112 includes multi-chamber integrated interface 180 that provides fluid communication of interior of middle container with tray 114. Interface 180 includes a multi-chamber structure that allows pressurized gas from interior of middle container to exit into interface and then pass onto tube 116 to provide pressurized fluid flow down into tray. Clear sealing disc is preferably made of transparent plastic, or glass, and provides a seal over interface to prevent liquid and gas passing out of interface (see also FIG. 11 for assembled embodiment with exploded interface pans). Window disc 119 is provided with window 129 to allow viewing of liquid and gases in interface to monitor the progress of CO passing through interface. Tubing 116 provides access to tray 114, as will be explained below.

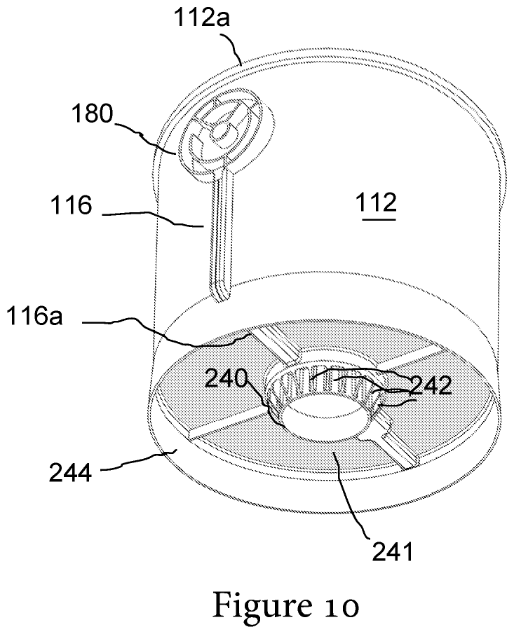

Tray 114 acts as holding container to support middle container 112 via boss 140. Boss 140 includes slightly smaller circumference head 141 to engage with lower sections of middle container (as shown more clearly in FIG. 10). Tray includes rim 146 which provides the top ledge of the tray, and separates outer rough surface 145 from smooth interior surface 142, so as to encourage trapping of bedbugs crawling up sides 145, and unable to crawl up smooth surface 142.

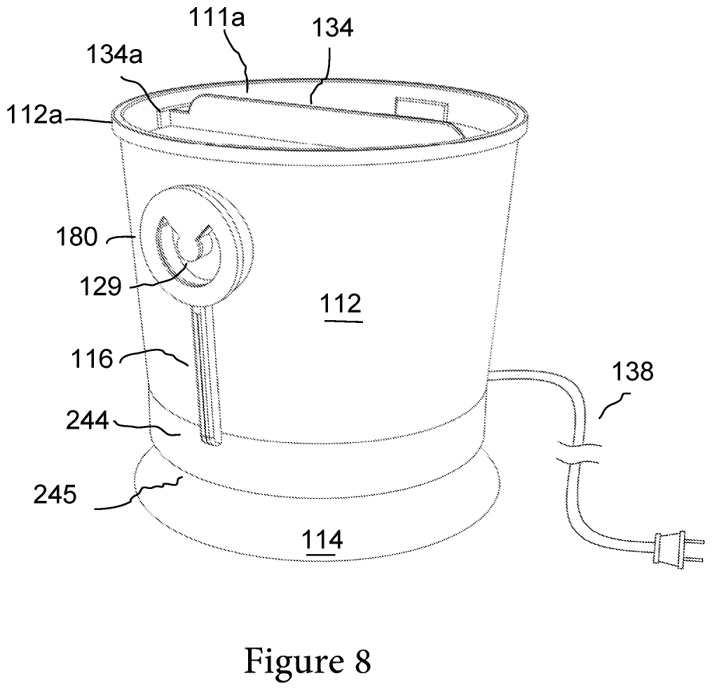

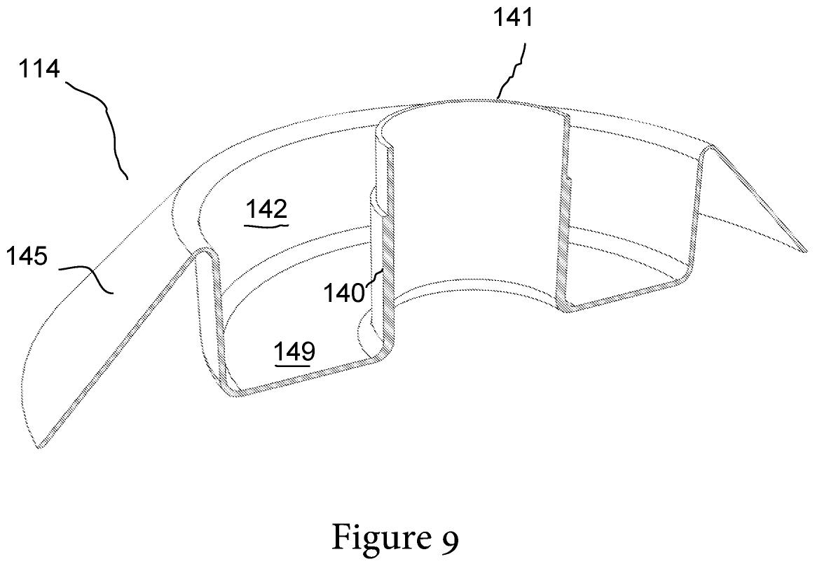

As can be seen in FIG. 8, the assembled system is shown. Middle container houses upper container therein. Lid 111a fits onto middle container to provide an airtight seal. Twist handle 134 in lid 111a allows for twist and seal thereon. Lid may also be simply emplaced therein. Indentations 134 accommodate lid and handle. 134. Middle container 112 includes upper rim 112a and skirt 244. Skirt 244 extends somewhat over tray 114, but should not rest on tray. Gap 245 as between skirt 244 and tray surface 145 should be large enough to allow bedbugs to enter, and CO₂ to escape. Interface 180 allows viewing through window 129 of liquid, and gas movement/bubbling, therein. Tube 116 provides for gas to pass out of middle container 112, once past interface 180, and directs down under skirt 244 into tray 114.

As can be seen in cross-sectional view of tray 114, tray includes rough outer surface 145 and smooth inner surface 142. Boss 140 extends upwardly with indented head 141 for receiving, and supporting, middle container. While boss and head are shown a circular, any shape that complements bottom of complementary feature in middle container may be used, including but not limited to square, star, rectangle, triangle, bar, U-shape, etc., however shapes with symmetric sections are preferred. Bottom 149 of tray 114 may be outfitted with diatomaceous earth as discussed above. Additionally, bottom 149 (and or other parts of tray) may be outfitted with a second heating element. The second heating element is preferably heated to approximately 104 degrees F., give or take six degrees F., so as to give off heat to the surroundings, simulate a heated person, and attract bedbugs. Thus, as dual heated system, is preferred, wherein the mixture is heated to about 80 degrees F., give or take 10 degrees F., and the tray (and CO2 therein) is heated above 100 degrees F. In some embodiments, the heating element 112b serves dual purpose, and is provided along tray to impart more heat to tray than to mixture above. In further embodiments, heating element 112b is removed, and replaced solely with heater in tray to heat tray and rising heat energy to warm the mixture in upper container.

As can be seen more readily in FIG. 10, lower surface 241 of middle container 112 includes lateral tubing 116a in communication with engaging ring 240 (circular or otherwise to complement boss/head of tray). Engaging ring is adapted to rest on head. Slots 242 are preferably arranged around ring 240 to allow escape of forced CO₂ from tubing into tray. CO exits middle container via interface 180 (shown here exposed) and through tubing 116 and 116a to tray (not shown).

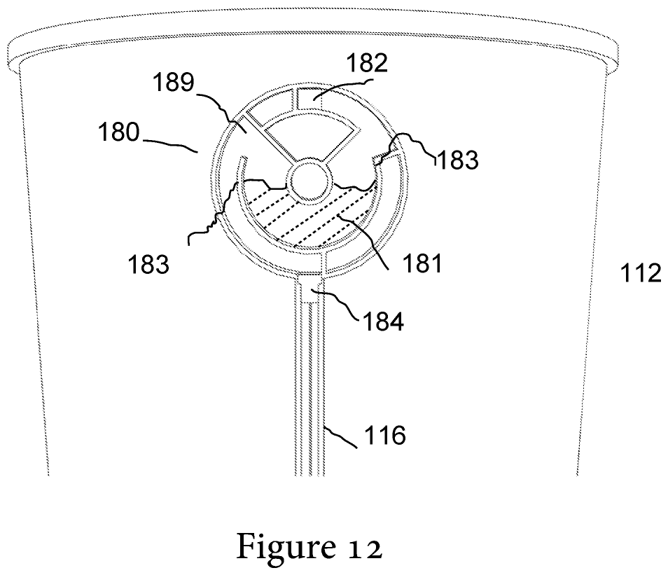

As shown in FIG. 12, the interface (with layers removed/missing) is shown. Interface 180 is formed in side of middle container 112, and provides fluid communication from the interior of middle container to tubing 116. Entry way 182 allows CO₂ gas to escape middle container, under pressure, and enter into chamber 189 of intertace 180. CO₂, or other gases, are encouraged via walls 183 to pass from entry way 182 through water/fluid 181 (from right to left), often as bubbles, and out exit 184 to tubing 116. When actively sealed and producing CO₂, the gas will bubble through liquid 181 on its way through system, thus allowing monitoring through window (not shown).

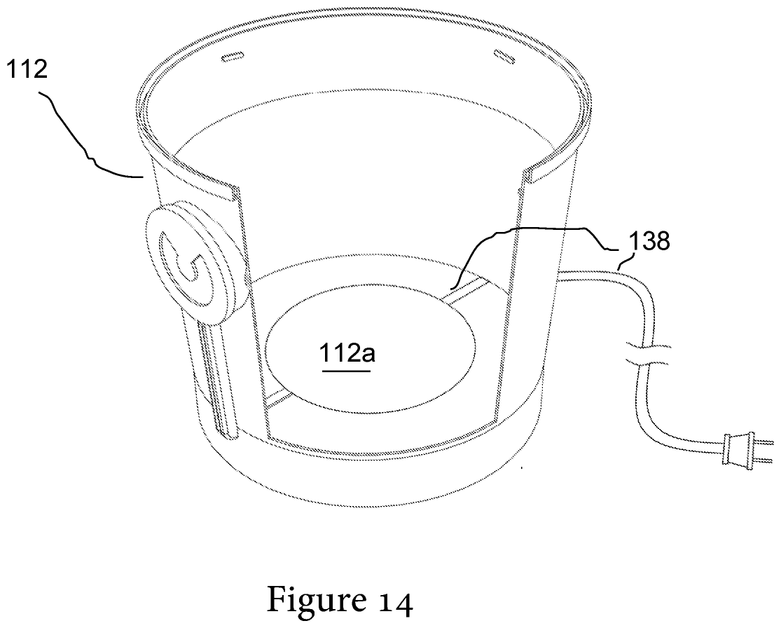

As seen in FIGS. 13 and 14, middle container 112 includes rim and tabs 131 on interior surface 135. Ledge 225 allows for resting of the upper container, when emplaced therein. Interface is provided within wall of middle container 112, and tubing may be set outside middle container, or may be placed within the wall. Lateral tubing 116a meets with engaging ring 240 and exits through slots over tray (not shown). Heating element 112b can be placed over lateral tubing and engagement ring to further direct escaping CO₂/gas into tray. Power to beating element 112b (and optionally second heater in tray) may be provided by power cord 138.

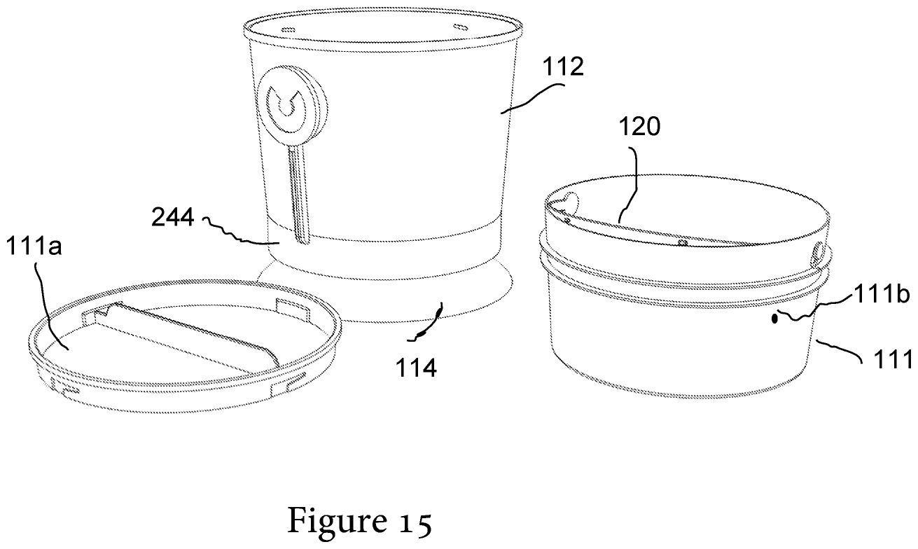

Disassembled system can be seen with all retail parts are shown in FIG. 15. Middle container 112 may be removeable from tray, or integral therewith. Upper container allows for holding mixture and can be held with handle 120. Optional aperture 111b may be provided. Lid 11a its over upper container (preferably not touching upper container) and engages a fluid/air-tight seal against middle container. Skirt 244 serves to retain and slow release of CO₂ from tray, and otherwise concentrate the CO₂.

In the preferred embodiment, the containers are large (up to five gallons for the top container). However, the device may be made in any size. For example, a small travel unit with a top container of the quart size can be used, if desired, in a hotel room, for example. Although not as effective as the larger units, it can help and, if nothing else, can provide peace of mind.

I claim:

1. A bedbug trap comprising:
a) an upper container having a carbon dioxide generator installed therein and having a top with a hose extending outwardly from said top;
b) a middle container, having a heat source container therein;
c) a lower container having a plurality of holes formed around a lower perimeter of said lower container; and
d) a holding container having a rough outer surface and a smooth inner surface;
e) wherein said upper container is set in said middle container and said middle container is set on top of said lower container and further wherein said lower container is set within said holding container; and further wherein, said hose from said upper container is positioned in said lower container.

2. The bedbug trap of claim 1 wherein said hose has a water trap installed therein.

3. The bedbug trap of claim 1 wherein said heat source maintains the carbon dioxide generator.

4. The bedbug trap of claim 1 wherein said carbon dioxide generator is a mixture of a quantity of warm water, sugar and yeast.

5. The bedbug trap of claim 4 wherein said quantity of warm water is brought to a temperature of 100° F.

6. The bedbug trap of claim 4 wherein said quantity of warm water is brought to a temperature of between about 105° and 107° F.

7. The bedbug trap of claim 1 wherein said beat source is an electric heating pad.

8. The bedbug trap of claim 2 wherein said water trap comprises a brewing S-type airlock.

9. The bedbug trap of claim 2 wherein said water trap comprises a loop formed in said hose and further wherein said loop contains a quantity of water therein.

10. The bedbug trap of claim 1 wherein said holding container has a quantity of a powdered insecticide therein.

11. The bedbug trap of claim 1 wherein said upper and middle containers are wrapped in insulation batting.

12. The bedbug trap of claim 10 wherein the powdered insecticide is diatomaceous earth.

13. A bedbug trap comprising:
a) an upper container having a carbon dioxide generator installed therein and having an open top exposed to an interior of a middle container;
b) the middle container housing the upper container and having a heat source container therein, the middle container including an interface and tubing in fluid communication with the interior of the middle container, the tubing directing gas from interface to a plurality of holes formed in a bottom of the middle container;
c) a holding container including complementary structure to mate with a bottom of the middle container, the plurality of holes exposed to an interior of the tray, the tray having a rough outer surface and a smooth inner surface.

14. A bedbug trap comprising:
a) an upper container having a carbon dioxide generator installed therein, the generator in fluid communication with an interior of a middle container;
b) the middle container housing the upper container and directing heat below the upper container, the middle container including an interface and tubing in fluid communication with the interior of the middle container, the tubing directing gas from interface to a bottom of the middle container;
c) a holding container including complementary structure to mate and support the middle container, the bottom of the middle container providing fluid communication to a portion of an interior of the tray.
